(19) United States
(12) Patent Application Publication
(10) Pub. No.: US 2009/0269721 A1
(43) Pub. Date: Oct. 29, 2009

(54) Footprints for dental cavity filling with composite material

(76) Inventor: Daniel A. Metz, Wayside, NJ (US)

Correspondence Address: Charles I. Brodsky, 2 Bucks Lane, Marlboro, NJ, 07746, US

(21) Appl. No.: 12/150,274

(22) Filed: Apr. 28, 2008

(51) Int. Cl. A61C 5/00

(52) U.S. Cl. 433/217.1

(57) ABSTRACT

Instead of carving, contouring and shaping a tooth and its occlusal surfaces to give a patient a comfortable, non-grinding bite, an impression mold is first used to exactly reproduce the anatomy of the tooth before any cavity preparation is initiated, on the one hand, or to recreate the anatomy of a fractured or chipped tooth to be rebuilt, on the other hand.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the filling of dental cavities, in general, and to the filling of dental cavities with composite material, in particular.

2. Description of the Related Art

As will be appreciated, the last steps in the filling of dental cavities with composite material is the carving, contouring and shaping of the tooth and occlusal surfaces to give to the patient a comfortable, non-grinding bite. As will also be appreciated, this process generally entails the repetitive use of articulating paper and various sized burrs to produce the desired result. As will additionally be appreciated, this process is inordinately time consuming, and arguably inexact.

### OBJECTS OF THE INVENTION

It is an object of the present invention, therefore, to provide an improved way for the dentist to fill these cavities with composite material.

It is an object of the present invention, also, to provide a way for the dentist to accomplish the filling faster, and more exactly.

It is another object of the invention to provide a manner for the dentist to accomplish this in a way that produces these results regardless of the anatomy of the patient's tooth to begin with.

It is a further object of the invention to provide to the dentist different methods of accomplishing the final result both for molars and bicuspids in different quadrants of a patient's mouth—both for chipped and/or fractured teeth, and for teeth of normal anatomy alike.

It is an additional object of the invention to provide this method for the dentist so that the patient will leave the office with as comfortable a bite as when entering the office.

### SUMMARY OF THE INVENTION

As will become clear from the following description, the present invention specifically covers what are termed “footprints” for the dental cavity filling with composite material. According to the invention, one “footprint” is designated “custom” while the second is designated “standard”—with the commonality between them being that they each provide an imprint of the dental cusps for the shaping of the tooth to a comfortable, non-biting fit.

As will be seen, the “custom footprint” provides a reproduction of the precise anatomy of the patient's tooth, while the “standard footprint” provides an anatomy that the patient's tooth should have had initially. In essence, both serve to replicate a desired tooth structure.

More specifically, the “custom footprint” employs special molds to be used in making an impression of the patient's tooth to provide its exact contour before any decay is removed. Such impression would include all the grooves and cusps of the tooth—whether it be a molar or a bicuspid. In a preferred arrangement for the marketing of the “custom footprint” method, a case may be provided to house as a starting point two or more special molar molds and two or more special bicuspids molds. A glycerine or other lubricant may also be included.

With the “standard footprint” method, on the other hand, some 8 or so preformed molds for molars and 8 for bicuspids may be provided in the case. These molds represents the size and shape of the teeth as typically found in the different quadrants of a patient's mouth.

In the “custom footprint” embodiment, the special molds for taking the impression include a series of deployable, and then lockable, fibers, filaments or wires whose extension from a quiescent setting is reflective of the various grooves and cusps in the occlusal surfaces of the tooth. Once the impression is taken, the mold is set aside. After the decay has been drilled out by the Dentist, and the composite filling material layers have been built up in the cavity, the mold is pushed down back in place. This reproduces the actual structure of the original tooth—and with the ends of the fibers, filaments or wires being coated with glycerine or a like lubricant, little composite material sticks to their respective ends upon removal. These special molds may be “finger-held” or provided at the end of a handle attachment.

In the “standard footprint” embodiment, the molar and bicuspid molds are provided at handle ends and allow for a final shaping of a tooth which is either chipped or fractured—generally, one where a “custom footprint” impression in a mold might not be enough.

It will thus be seen that the “custom footprint” embodiment serves to reproduce the tooth structure that was originally presented by the patient, while the “standard footprint” embodiment serves to recreate a desired anatomy.

### BRIEF DESCRIPTION OF THE DRAWINGS

These and other features of the present invention will be more clearly understood from a consideration of the following description, taken in connection with the accompanying Drawings, in which:

FIGS. 1a, 1b and 1c are front, top and right-side views, respectively, of a mold according to the “custom footprint” embodiment of the invention to be used, for example, for taking an impression of a tooth whose dental cavity is to be filled with composite material, as shown in FIG. 2;

FIG. 3 is a cross-sectional view of the insides of the mold of FIGS. 1a-1c helpful in an understanding of the “custom footprint” embodiment of the invention;

FIG. 4 illustrates a type of case for housing various ones of the molds constructed in accordance with the “custom-footprint” embodiment;

FIGS. 5a and 5b are side and bottom views, respectively, of a hand-held mold according to the “standard footprint” embodiment of the invention; and

FIG. 6 illustrates a type of case for housing ten “standard footprint” molds for recreating molars and bicuspids according to the “standard footprint” embodiment.

### DETAILED DESCRIPTION OF THE INVENTION

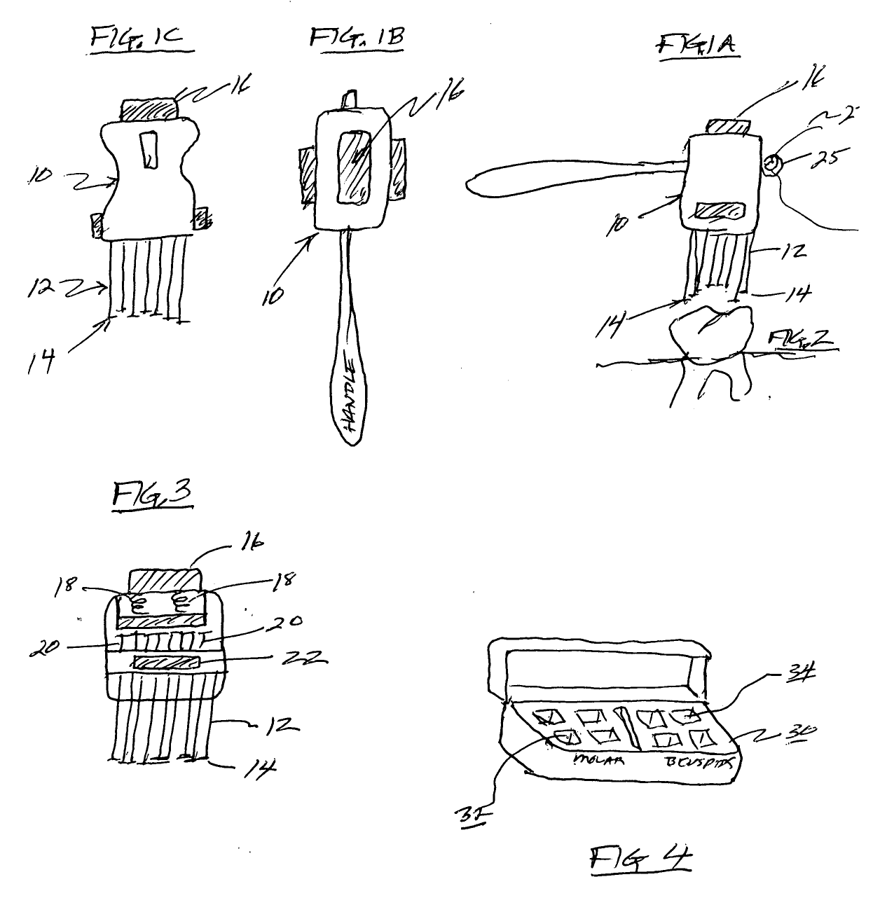

The “custom footprint” special mold 10 of FIGS. 1a, 1b and 1c includes a plurality of deployable fibers, filaments or wires 12 having flat or ball-shaped ends 14 to fit within various grooves of the tooth's occlusal surfaces as shown in FIG. 2. As illustrated in FIGS. 1a and 1c, the fibers, filaments or wires extend side-to-side and front-to-back from the underside of the mold 10. A set/reset button 16 at the top of the mold actuates included springs 18 to drive a series of plungers 20 to extend the fibers, filaments or wires (FIG. 3). Once set, they are then fixed in place by a lock/unlock button 22. The effective patterns of the fibers, filaments or wires when locked represents the contour of the tooth to be drilled. The mold 10 is then set aside while the Dentist continues with drilling out the decay and preparing the tooth to be filled with composite material.

After the drilling is completed, and the composite layers have been added to fill the cavity, the mold 10 is placed back down onto the tooth. This allows the ends 14 of the fibers, filaments or wires to push away any excess material beyond the initial tooth anatomy. The button 22 is unlocked to release the fibers, filaments or wires, and the button 16 is depressed to reset the fibers, filaments or wires to their quiescent position. An exact replica of the tooth structure results, providing the patient with the same bite and grind characteristics as existed before the procedure began.

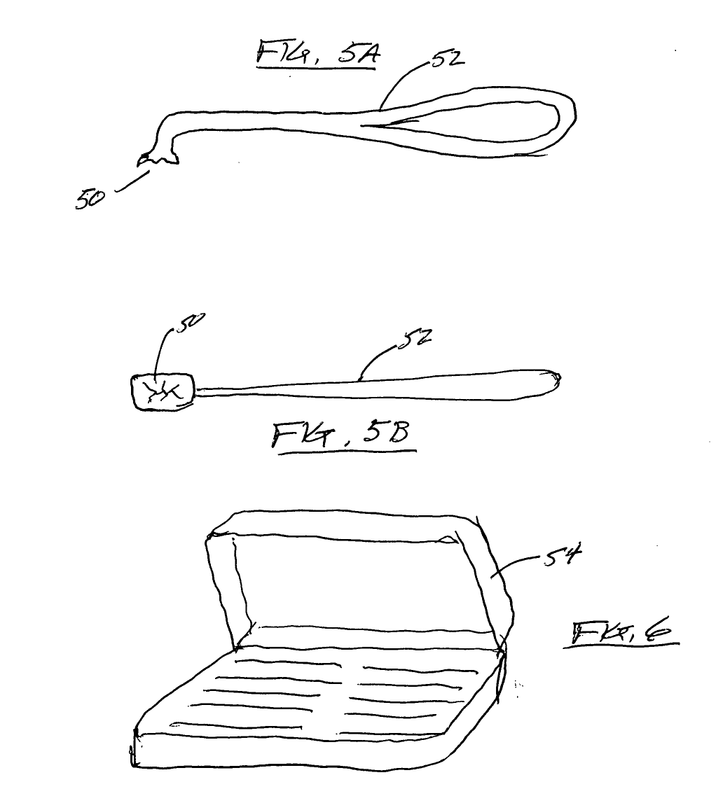

FIG. 4 shows a case 30 with four compartments to receive, for example, two special molds for molar use at 32 and two compartments for bicuspid use at 34. Space could also be provided for housing a container of glycerine or like liquid lubricant for dabbing on the ends 14 of the fibers, filaments or wires. This would coat the ends so that no composite material would adhere upon their withdrawal to the quiescent position.

In one construction of this embodiment, a hook 25 is provided on a side of the mold 10 to receive a length of dental floss 27, for example. This serves as a safety precaution to retrieve a mold accidentally dropped in the patient's mouth and possibly being swallowed. A handle attachment could be utilized instead to hold the mold to retrieve it.

The “standard footprint” embodiment of FIGS. 5a and 5b includes fixed molds 50 on handle attachments 52. A case 54 for ten molds, for example, is shown in FIG. 6, five designs for molars, and five designs for bicuspids. A container of glycerine or other lubricant could be packaged, and the exact number of molds packaged follows a determination of the size and shape most usable for the quadrants of a patient's mouth. Again, once the decay has been drilled out and the layers of composite material built up, the Dentist places the appropriate mold in position to recreate the shape and structure that the tooth should normally have. As such these “standard footprint” molds are best suited for teeth that have been fractured or chipped, where a recreation of tooth anatomy would be beneficial.

While there have been described what are considered to be preferred embodiments of the present invention, it will be readily appreciated by those skilled in the art that modifications can be made without departing from the scope of the teachings herein. With either embodiment, a quick form structure is provided to simplify the production of a comfortable bite and grind characteristic. Whereas the “custom footprint” embodiment allows for a precise reproduction of the anatomy that was on the original tooth, and while the “standard footprint” embodiment yields a perfect impression of the anatomy that should be exhibited, both allow the filling of a dental cavity with composite material fast, efficiently and exactly—and both provide for a replication of a desired tooth structure. For such reason, therefore, resort should be had to the claims appended hereto for a true understanding of the scope of the invention.

I claim:

1. A method for incorporating composite material to replicate the initial anatomy of a dental tooth comprising the steps of:
first, building up the tooth structure with successive layers of composite material until an approximate shape of the desired tooth anatomy is reached; and
second, pressing down the built up tooth structure with a mold of a size and shape reflective of the final anatomy desired.

2. The method of claim 1 wherein said second step presses down the built up tooth structure with a molar or bicuspid configured mold of size and shape consistent with the quadrant of a patient's mouth where the tooth is positioned.

3. The method of claim 2 wherein said second step presses down with a molar or bicuspid configured mold located at one end of a handle attachment.

4. The method of claim 1 wherein said first step builds up the tooth structure of a chipped or fractured tooth with successive layers of composite material.

5. The method of claim 1 wherein said first step builds up the tooth structure of a chipped or fractured tooth with successive layers of composite material to recreate a desired tooth structure.

6. The method of claim 5 wherein said second step presses down the built up tooth structure with a molar or bicuspid configured mold of size and shape consistent with the quadrant of a patient's mouth where the tooth is positioned.

7. The method of claim 1, including an initial step of making an impression mold of a tooth to be filled with the composite material before any dental drilling commences, wherein said first step builds up the tooth structure with said successive layers of composite material after dental drilling has commenced, and wherein said second step presses down the built up tooth structure with said impression mold.

8. The method of claim 7 wherein said initial step makes an impression mold by deploying individual ones of fibers, filaments and wires into the grooves and cusps of the occlusal surfaces of the tooth.

9. The method of claim 8 wherein said initial step makes an impression mold by deploying individual ones of fibers, filaments and wires into the grooves and cusps of the occlusal surfaces of the tooth from side-to-side and from front-to-back.

10. The method of claim 9 wherein said initial step releasably locks said fibers, filaments and wires in place corresponding to the contours of the tooth structure.

11. The method of claim 10 wherein said second step presses down said impression mold to reproduce the desired tooth structure.
